(19) United States
(12) Patent Application Publication
(10) Pub. No.: US 2026/0251202 A1
(43) Pub. Date: Aug. 27, 2026

(54) POWER TRANSMISSION DEVICE

(71) Applicant: TSUBAKIMOTO SPROCKET CO., Kuze-gun, Kyoto (JP)

(72) Inventor: Yuji Yamanaka, Kyoto (JP)

(73) Assignee: TSUBAKIMOTO SPROCKET CO., Kuze-gun, Kyoto (JP)

(21) Appl. No.: 18/854,931

(22) PCT Filed: Apr. 6, 2023
(86) PCT No.: PCT/JP2023/014158

§ 371 Date: Oct. 7, 2024

(30) Foreign Application Priority Data
Apr. 13, 2022 (JP) 2022-066153

(51) Int. Cl. F16H 1/06; F16H 55/17

(52) U.S. Cl. CPC F16H 1/06; F16H 55/17

(57) ABSTRACT

A power transmission device includes a first power transmission member including first meshing portions arranged next to each other in a circumferential direction and a second power transmission member including second meshing portions that are capable of meshing with the first meshing portions. The second power transmission member rotates or moves in a second direction as the first power transmission member rotates. The first power transmission member includes a hub, a gear, a first engagement portion that moves integrally with the hub in a rotation direction of the hub, and a second engagement portion provided on the gear to be engageable with the first engagement portion in the rotation direction of the hub.

### TECHNICAL FIELD

The present disclosure relates to a power transmission device in which power transmission members are coupled so as to transmit power.

### BACKGROUND

This type of power transmission device, for example, is known as the rotation-to-linear motion conversion device described in Patent Literature 1. This conversion device includes a rack with teeth and a pinion with rollers that mesh with the teeth of the rack. The rack is fixed to a base that is arranged to move horizontally such that the rack extends in the direction of the horizontal movement of the base. The pinion is arranged to rotate with some of its rollers meshing with the teeth of the rack. The rotational movement of the pinion, which is a driving-side power transmission member, is transmitted to the rack, which is a driven-side power transmission member, and is converted into linear movement. Thus, the base is configured to move horizontally along with the rack.

### CITATION LIST

### Patent Literature

Patent Literature 1: Japanese Laid-Open Patent Publication No. 10-184842

### SUMMARY OF INVENTION

### Technical Problem

In the above-described rotation-to-linear motion conversion device, which is an example of the power transmission device, the base to which the rack is fixed may thermally expand due to relatively high temperatures or may be displaced due to interference from other components. In such cases, the rack fixed to the base is also displaced. If, for example, the rack is displaced in the axial direction of the pinion, the pinion may disengage from the teeth of the displaced rack. As a result, there is a risk that power will not be transmitted from the pinion, which is the driving-side power transmission member, to the rack, which is the driven-side power transmission member.

### Solution to Problem

A power transmission device according to an aspect of the present disclosure includes a first power transmission member. The first power transmission member includes first meshing portions arranged next to each other in a circumferential direction about an axis extending in a first direction. The first power transmission member is rotatable about the axis. The power transmission device also includes a second power transmission member. The second power transmission member includes second meshing portions that are arranged next to each other in a second direction intersecting the first direction and are capable of meshing with the first meshing portions. The second power transmission member rotates or moves in the second direction as the first power transmission member rotates with the first meshing portions meshed with the second meshing portions. The first power transmission member includes a hub that rotates about the axis and a gear including the first meshing portions on an outer circumferential side of the gear and an insertion hole on an inner circumferential side of the gear. The hub is inserted through the insertion hole to be slidable in the first direction. The first power transmission member also includes a first engagement portion that moves integrally with the hub in a rotation direction of the hub and a second engagement portion provided on the gear to be engageable with the first engagement portion in the rotation direction of the hub.

### BRIEF DESCRIPTION OF DRAWINGS

FIG. 1 is a side view, with a part cut away, schematically showing the overall configuration of a rotary kiln including a power transmission device according to a first embodiment.

FIG. 2 is a perspective view schematically showing a main part of the power transmission device in the first embodiment.

FIG. 3 is a cross-sectional view taken along line 3-3 in FIG. 2.

FIG. 4 is a cross-sectional view showing a state in which the gear slides relative to the hub from the state of FIG. 3.

FIG. 5 is a perspective view schematically showing a main part of the power transmission device according to a second embodiment.

FIG. 6 is a cross-sectional view taken along line 6-6 in FIG. 5.

FIG. 7 is a cross-sectional view showing a state in which the gear slides relative to the hub from the state of FIG. 6.

### DESCRIPTION OF EMBODIMENTS

### First Embodiment

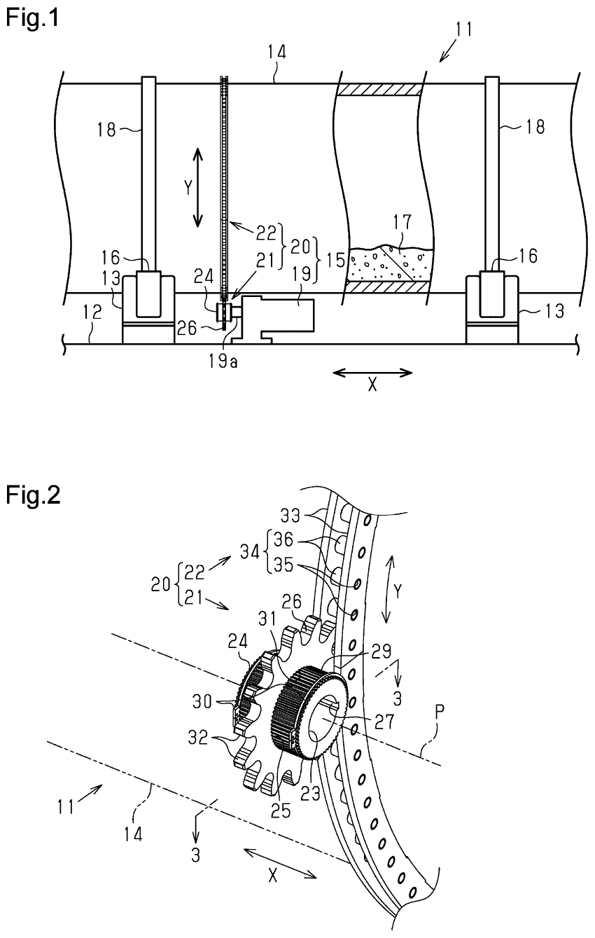

A first embodiment of a power transmission device included in a rotary kiln will now be described with reference to FIGS. 1 to 4.

### Rotary Kiln

As shown in FIG. 1, the rotary kiln 11 includes support devices 13 installed on a base 12, a rotary drum 14 rotatably supported by the support devices 13, and a drive device 15 that rotates the rotary drum 14. The support devices 13 are arranged in a pair, spaced a certain distance apart in the longitudinal direction of the rotary drum 14, which corresponds to the left-right direction in FIG. 1. A roller 16 that rotatably supports the rotary drum 14 is provided on an upper portion of each support device 13. The rotary drum 14 is a cylindrical body with an internal space that is configured to be heated. The rotary drum 14 is loaded with a powdered sample 17, such as sludge or cement. An annular rail 18 is mounted along the entire circumference of the outer circumferential surface of the rotary drum 14 at the location corresponding to the roller 16 of the support device 13 in the longitudinal direction of the rotary drum 14. The rail 18 is designed to be in rolling contact with the roller 16. The drive device 15 includes a motor 19 and a power transmission device 20 that transmits power that has been output from the motor 19.

### Power Transmission Device

As shown in FIGS. 1 and 2, the power transmission device 20 of the present embodiment includes a first power transmission member 21 attached to an output shaft 19a of the motor 19, and a second power transmission member 22 attached to the rotary drum 14 of the rotary kiln 11. In FIG. 2, the motor 19 and its output shaft 19a, which are shown in FIG. 1, are omitted to simplify the drawing. In the power transmission path where the motor 19 serves as the drive source, the first power transmission member 21 is located on the driving side, while the second power transmission member 22 is located on the driven side. That is, the power transmission device 20 transmits power from the drive-side first power transmission member 21, which rotates integrally with the output shaft 19a of the motor 19 by the driving of the motor 19, to the driven-side second power transmission member 22, which rotates integrally with the rotary drum 14.

### First Power Transmission Member

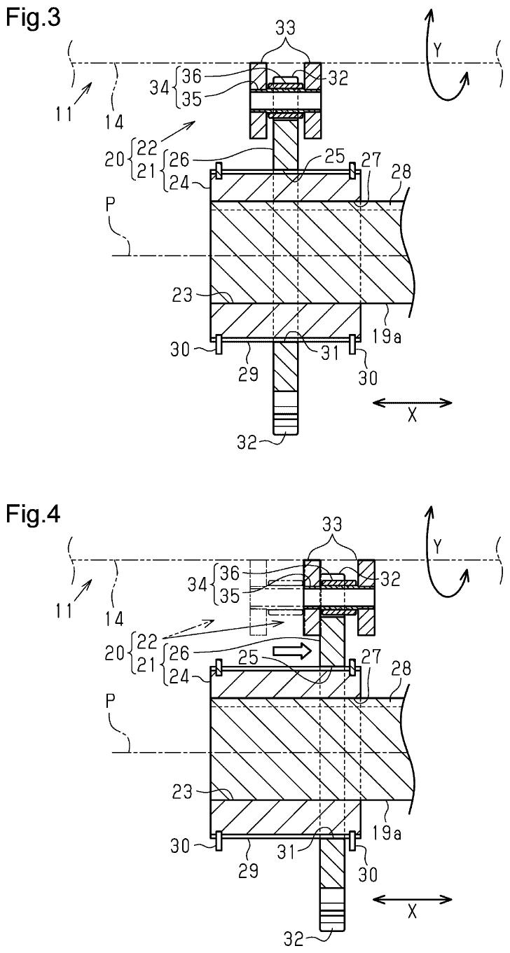

As shown in FIGS. 2 and 3, the first power transmission member 21 includes a hub 24 and a gear 26. The hub 24 is a cylindrical rotor having a shaft hole 23 into which the output shaft 19a of the motor 19 is inserted. The gear 26 includes an insertion hole 25 through which the hub 24 is slidably inserted. The inner circumferential surface of the shaft hole 23 in the hub 24 includes a key groove 27 that extends in a first direction X, which corresponds to the left-right direction in FIG. 3. The outer circumferential surface of the output shaft 19a of the motor 19 includes a projecting key 28 that extends in the first direction X. The projecting key 28 aligns with the key groove 27 when the output shaft 19a is inserted into the shaft hole 23. Thus, when the motor 19 is driven with the output shaft 19a of the motor 19 inserted into the shaft hole 23, the hub 24 rotates integrally with the output shaft 19a of the motor 19 about an axis P in the first direction X.

### Hub

As shown in FIGS. 2 and 3, splines 29 extend along the axis P over the entire circumference of the outer circumferential surface of the hub 24. These splines 29 correspond to at least one protrusion provided on the outer circumferential surface of the hub 24 in the first direction X so as to be included in a first engagement portion. The first engagement portion moves integrally with the hub 24 in the rotation direction of the hub 24. In addition, retaining rings 30 are detachably attached to the ends of the hub 24 in the first direction X along the axis P, respectively. The retaining rings 30 each function as a retaining part that prevents the gear 26, in a state in which the hub 24 is slidably inserted through the insertion hole 25, from falling off from the end of the hub 24 in the first direction X.

### Gear

As shown in FIGS. 2 and 3, spline grooves 31 extend along the axis P over the entire circumference of the inner circumferential surface of the insertion hole 25 in the gear 26. These spline grooves 31 correspond to at least one recess provided in the first direction X so as to be included in a second engagement portion on the inner circumferential surface of the insertion hole 25 in the gear 26. That is, when the hub 24 is inserted through the insertion hole 25 of the gear 26, the spline grooves 31 are respectively engaged with the splines 29, which are at least one protrusion included in the first engagement portion, in the rotation direction of the first power transmission member 21.

The splines 29 as the first engagement portion and the spline grooves 31 as the second engagement portion are slidable in the first direction X while being respectively engaged with each other in the rotation direction of the first power transmission member 21. Thus, in the first power transmission member 21 including the hub 24 and the gear 26, the hub 24 and the gear 26 are integrally rotatable about the axis P with the splines 29 as the first engagement portion and the spline grooves 31 as the second engagement portion respectively engaged with each other. In addition, the outer circumference of the gear 26, having the insertion hole 25 on its inner circumferential side, includes first meshing portions 32. The first meshing portions 32 are teeth arranged next to each other in the circumferential direction about the axis P in the first direction X.

### Second Power Transmission Member

As shown in FIGS. 2 and 3, the second power transmission member 22 is fixed to the outer circumferential surface of the rotary drum 14 of the rotary kiln 11 at a position corresponding to the gear 26 of the first power transmission member 21 in the first direction X. The second power transmission member 22 extends over the entire circumference of the rotary drum 14. The second power transmission member 22 includes two annular side plates 33 forming a pair and multiple second meshing portions 34. The second meshing portions 34 are arranged next to each other in the circumferential direction between the annular side plates 33. The two annular side plates 33 are fixed on the outer circumferential surface of the rotary drum 14 to face each other at a distance. The distance is larger than the thickness of the gear 26 in the first direction X. As shown in FIG. 2, the annular side plate 33 may be formed by joining arcuate plate members to the outer circumferential surface of the rotary drum 14, with the plate members coupled to each other in the circumferential direction.

Each second meshing portion 34 includes a pin 35 and a roller 36. The pin 35 is extended between the annular side plates 33 in the first direction X. The roller 36 is externally fitted to the pin 35 to be rotatable relative to the pin 35 in a loosely-fitted state. The pins 35 are arranged at intervals to mesh with the first meshing portions 32 of the first power transmission member 21 in a second direction Y, which corresponds to the circumferential direction of the rotary drum 14, intersecting the first direction X. When the second meshing portions 34 mesh with the first meshing portion 32 of the first power transmission member 21, the second power transmission member 22, which has the shape of a pin rack, rotates in the second direction Y as the first power transmission member 21 rotates.

Operation of First Embodiment

As shown in FIG. 4, for example, when the rotary drum 14 of the rotary kiln 11 is thermally expanded in the first direction X, the second power transmission member 22 may be displaced in the direction indicated by the blank arrow from the position indicated by the long dashed double-short dashed line. In this case, the two annular side plates 33 of the second power transmission member 22 forming a pair in the first direction X are also displaced in the first direction X. During the displacement, the annular side plate 33 on the rear side in the displacement direction of the two annular side plates 33 comes into contact with the gear 26 of the first power transmission member 21 from the rear side in the displacement direction.

When the second power transmission member 22 is further displaced in the first direction X while remaining in contact, the gear 26 of the first power transmission member 21 is pushed by the annular side plate 33 and thus moved in the first direction X. The annular side plate 33 of the second power transmission member 22 functions as a contact portion. When the second power transmission member 22 is displaced in the first direction X, the contact portion moves the gear 26 in the displacement direction of the second power transmission member 22 by coming into contact with the first power transmission member 21 in the first direction X. In the same manner as the second power transmission member 22, the gear 26 is thus displaced in the first direction X while sliding on the hub 24. This allows the first meshing portions 32 of the first power transmission member 21 to remain meshed with the second meshing portions 34 of the displaced second power transmission member 22.

If, for example, the gear 26 were not configured to slide relative to the hub 24, and instead, the hub 24 and the gear 26 were machined as a single unit from the same steel material, the following issues would arise. First, the amount of material removed during machining would be greater than that in the present embodiment, leading to an increase in manufacturing costs. Second, although reducing the thickness of the gear 26 in the first direction X to maintain the meshing state with the second power transmission member 22 displaced in the first direction X after displacement might be one solution, this would significantly reduce the permissible load of the first meshing portion 32 that engages with the second meshing portion 34.

In the present embodiment, the gear 26 is configured to slide relative to the hub 24. This limits a decrease in the permissible load of the first meshing portion 32 that meshes with the second meshing portion 34. Further, there may be a case in which the second power transmission member 22 is expected to be displaced by a relatively large amount in the first direction X depending on the environment in which the power transmission device 20 is installed. In this case, replacing the hub 24 attached to the output shaft 19a with a longer hub allows the same gear 26 to continue being used.

Furthermore, there may be a case in which the gear 26 is pushed by the annular side plate 33 of the second power transmission member 22 to move in the first direction X and is about to fall off from the end of the hub 24 in the first direction X. In this case, the retaining ring 30 prevents the gear 26 from falling off by coming into contact with it in the first direction X. Additionally, removing the retaining ring 30 from the end of the hub 24 allows the gear 26 to be replaced with a new one.

### Advantages of First Embodiment

(1-1) Even when the second power transmission member 22 is displaced in the first direction X relative to the first power transmission member 21, the meshing state between the first meshing portions 32 and the second meshing portions 34 is maintained by sliding the gear 26 of the first power transmission member 21 relative to the hub 24 in the displacement direction. As a result, power continues to be transmitted effectively between the first power transmission member 21 and the second power transmission member 22.
(1-2) When the second power transmission member 22 is displaced in the first direction X, the annular side plate 33 on the rear side in the displacement direction of the two annular side plates 33 pushes the gear 26 of the first power transmission member 21 in the displacement direction. This allows the gear 26 to slide relative to the hub 24 and be displaced in the first direction X. Thus, the gear 26 of the first power transmission member 21 is displaced as the second power transmission member 22 is displaced. This allows the first meshing portions 32 to remain meshed with the second meshing portions 34.
(1-3) When the gear 26 is displaced while sliding relative to the hub 24 in accordance with the displacement of the second power transmission member 22 and the gear 26 is about to fall off from the hub 24, the retaining ring 30 prevents the gear 26 from falling off from the hub 24 by coming into contact with the gear 26.
(1-4) For example, there may be cases where the first meshing portions 32 of the gear 26 being used become worn or damaged. In these cases, removing the retaining ring 30 from the hub 24 allows the old gear 26 with the worn first meshing portions 32 to be replaced with a new gear 26, which has unworn first meshing portions 32.
(1-5) The first engagement portion includes the splines 29. The second engagement portion includes the spline grooves 31. This easily enables the gear 26 to be rotatable integrally with and slidable relative to the hub 24.

### Second Embodiment

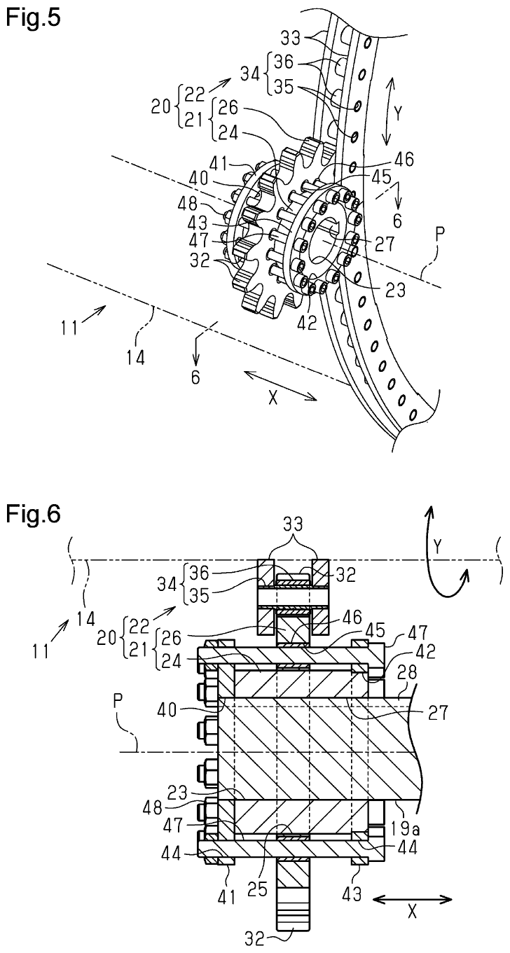

A power transmission device 20 according to a second embodiment will now be described with reference to FIGS. 5 to 7. For members that are identical to those in the first embodiment of the present embodiment, the same reference numerals are used in the drawings, and redundant explanations regarding those members are omitted. That is, in the present embodiment, mechanisms and members having components different from those of the first embodiment will be mainly described.

### Power Transmission Device

As shown in FIGS. 5 and 6, the power transmission device 20 of the present embodiment also includes the first power transmission member 21, which is attached to the output shaft 19a of the motor 19, and the second power transmission member 22, which is attached to the rotary drum 14 of the rotary kiln 11. In the same manner as FIG. 2, the motor 19 and its output shaft 19a are not shown in FIG. 5 to simplify the drawing. The present embodiment is different from the first embodiment in the configuration of the first power transmission member 21. That is, the other members such as the second power transmission member 22 are the same as those of the first embodiment.

### First Power Transmission Member

The first power transmission member 21 of the present embodiment also includes the hub 24, which is a cylindrical rotor having the shaft hole 23, and the gear 26, which has the insertion hole 25 through which the hub 24 is slidably inserted. Further, the inner circumferential surface of the shaft hole 23 in the hub 24 includes a recessed key groove 27, which matches the key 28 on the outer circumferential surface of the output shaft 19a of the motor 19. In the present embodiment, the splines 29 and the spline grooves 31 included in the first embodiment are not provided on the outer circumferential surface of the hub 24 and the inner circumferential surface of the insertion hole 25 of the gear 26. That is, in the present embodiment, the outer circumferential surface of the hub 24 and the inner circumferential surface of the insertion hole 25 of the gear 26 are cylindrical surfaces facing each other with a slight gap that allows the gear 26 to slide in the first direction X relative to the hub 24.

In the present embodiment, a first ring-shaped plate 41 is welded to a distal end surface of the hub 24, which is the left end surface in FIG. 6. The first ring-shaped plate 41 has an outer diameter that is larger than that of the hub 24, and includes a fitting hole 40 at its center. The distal end of the output shaft 19a of the motor 19 is configured to be fitted into the fitting hole 40. A second ring-shaped plate 43 is detachably fitted to the right end of the hub 24 in FIG. 6. The second ring-shaped plate 43 has the same outer diameter as the first ring-shaped plate 41, and includes a fitting hole 42 having the same inner diameter as the outer diameter of the hub 24 at its center. The first ring-shaped plate 41 and the second ring-shaped plate 43 correspond to a retaining part. This retaining part prevents the gear 26 from falling off from the hub 24 by coming into contact with the gear 26 in the first direction X when the gear 26 slidable in the first direction X relative to the hub 24 is about to fall off from the end of the hub 24.

### First Engagement Portion and Second Engagement Portion

In the first ring-shaped plate 41 and the second ring-shaped plate 43, bolt insertion holes 44 are arranged at regular intervals in the circumferential direction in a section facing the gear 26 in the first direction X. The gear 26 includes fitting holes 45 at positions respectively facing the bolt insertion holes 44 of the first ring-shaped plate 41 and the second ring-shaped plate 43 in the first direction X, and includes plain bearings 46 that are respectively fitted and fixed to the fitting holes 45. Further, bolts 47 are respectively inserted in the first direction X from the bolt insertion holes 44 of the second ring-shaped plate 43 through the plain bearings 46 of the gear 26 to the bolt insertion holes 44 of the first ring-shaped plate 41.

Each bolt 47 does not have a male screw portion on the outer circumferential surface of its body. A male screw portion (not shown) is provided only on the distal end protruding from the bolt insertion hole 44 of the first ring-shaped plate 41. In addition, the bolt 47 is installed between the first ring-shaped plate 41 and the second ring-shaped plate 43 by fastening a nut 48 to the male screw portion of the distal end of the bolt 47. In the present embodiment, the bolt 47 is included in a first engagement portion that moves integrally with the hub 24 in the rotation direction of the hub 24. The plain bearing 46 through which the bolt 47 is inserted is included in a second engagement portion provided in the gear 26 to be engageable with the bolt 47, which is the first engagement portion, in the rotation direction of the hub 24.

### Operation of Second Embodiment

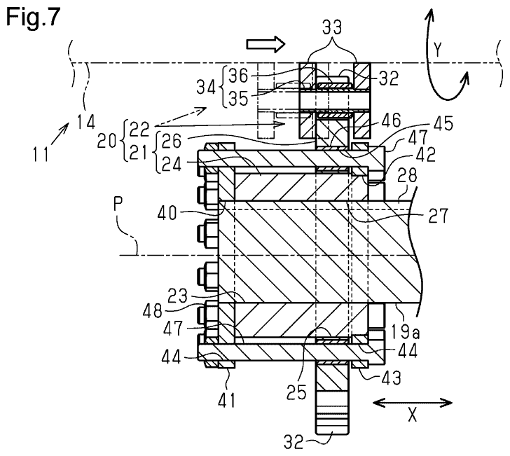

As shown in FIG. 7, also in the present embodiment, there may be a case in which the second power transmission member 22 is displaced in the direction indicated by the blank arrow from the position indicated by the long dashed double-short dashed line. In this case, the annular side plate 33 on the rear side in the displacement direction of the second power transmission member 22 pushes the gear 26 of the first power transmission member 21 in the displacement direction in the first direction X. Then, in the same manner as the second power transmission member 22, the gear 26 is thus displaced in the first direction X while sliding on the hub 24. Accordingly, the present embodiment also allows the first meshing portions 32 of the first power transmission member 21 to remain meshed with the second meshing portions 34 of the displaced second power transmission member 22.

In addition, there may be case in which the gear 26 is pushed in the first direction X by the annular side plate 33 of the second power transmission member 22 and is about to fall off from the end of the hub 24. In this case, the first ring-shaped plate 41 or the second ring-shaped plate 43 prevents the gear 26 from falling off. That is, in the present embodiment, the first ring-shaped plate 41 or the second ring-shaped plate 43 comes into contact with the gear 26, which moves in the first direction X and is about to fall off from the end of the hub 24, in the first direction X, thereby preventing the gear 26 from falling off. Additionally, removing the second ring-shaped plate 43 from the end of the hub 24 after loosening the bolt 47 and nut 48 enables replacement of the old gear 26 with a new one.

### Advantages of Second Embodiment

The present embodiment provides the following advantages in addition to advantages (1-1) and (1-2) in the first embodiment.
(2-1) When the gear 26 is displaced while sliding relative to the hub 24 in accordance with the displacement of the second power transmission member 22 and the gear 26 is about to fall off from the hub 24, the first ring-shaped plate 41 or the second ring-shaped plate 43 comes into contact with the gear 26 to prevent the gear 26 from falling off from the hub 24.
(2-2) To replace the gear 26, it is necessary to loosen the bolt 47 and then remove the second ring-shaped plate 43 from the end of the hub 24. This facilitates replacement of the gear 26.
(2-3) The first engagement portion includes a non-threaded body of the bolt 47, and the second engagement portion includes the plain bearings 46, through which the bolts 47 are respectively inserted. This allows for guiding and sliding of the gear 26 in the first direction X relative to the hub 24.

### Modifications

The above-described embodiments may be modified as follows. The features included in the above embodiment and the features included in the following modifications can be combined. Also, the features included in the following modifications can be combined.

In the first embodiment, the first engagement portion and the second engagement portion may be a combination of a key and a key groove instead of a combination of the splines 29 and the spline grooves 31. Alternatively, a combination of at least one projection having the same projecting height as the splines 29 and at least one recess that allows the projection to slide in the first direction X may be used. As another option, a combination of at least one recess provided on the outer circumferential surface of the hub 24 in the first direction X and at least one projection provided on the inner circumferential surface of the insertion hole 25 of the gear 26 in the first direction X may be used.

The retaining ring 30 or the second ring-shaped plate 43, each of which functions as the retaining part, may be configured to be detachably fixed to the end of the hub 24 in the first direction X.

The retaining part may be a retaining pin that includes a distal end and a basal end. The distal end is driven into the outer circumferential surface of the end of the hub 24 in the first direction X from outside in the radial direction. The basal end protrudes outward in the radial direction from the outer circumferential surface of the hub 24.

Instead of the pin 35 and the roller 36 externally fitted to the pin 35, the second meshing portion 34 may include only the pin 35 to which the roller 36 is not externally fitted.

In the first embodiment, the second power transmission member 22 has a pin-rack shape, which includes the two annular side plates 33 and the pins 35 with the rollers 36 externally fitted on them. Alternatively, the second power transmission member 22 may be a general-purpose rack shape with multiple teeth, serving as the second meshing portions 34, continuously arranged in the second direction Y. In this case, the gear 26 of the first power transmission member 21 that meshes the first meshing portions 32 with the second meshing portions 34 of the rack-shaped second power transmission member 22 has the following configuration.

Two ring-shaped plates having substantially the same outer diameter as that of the gear 26 of the first embodiment and including the spline grooves 31 formed in a central insertion hole 25 are slidably mounted on the hub 24. Further, pins or pins with rollers are provided between the two ring-shaped plates at equal intervals in the circumferential direction. In this case, the first meshing portions 32 are pins or pins with rollers. In addition, the two ring-shaped plates and the pins or pins with rollers are included in the gear 26 in which the first meshing portions 32 are provided on the outer circumferential side and the insertion hole 25, through which the hub 24 is inserted to be slidable in the first direction X, is formed on the inner circumferential side. When the rack-shaped second power transmission member 22 is displaced in the first direction X, one of the two ring-shaped plates is pushed in the displacement direction by the rack-shaped second power transmission member 22. As a result, when the second power transmission member 22 is displaced, the first power transmission member 21 is also displaced. Consequently, the first meshing portions 32 remain meshed with the second meshing portions 34.

The second power transmission member 22 does not have to be provided in a looped manner on the outer circumferential surface of a rotor, such as the rotary drum 14. Instead, it may be provided, for example, on a mobile unit that moves linearly in the movement direction of the mobile unit. In this case, the second power transmission member 22 moves not in a rotational motion but in a linear motion in the second direction Y as the first power transmission member 21 rotates, with the first meshing portions 32 and the second meshing portions 34 meshed with each other.

In the second embodiment, each plain bearing 46 may be omitted. In this case, it is preferable that the inner diameter of the fitting hole 45 to which the plain bearing 46 is fitted and fixed is adjusted to a diameter that allows for slidable insertion of the body of the bolt 47.

In the first embodiment, a lubricating configuration may be provided on the sliding surface between the splines 29, which are included in the first engagement portion on the outer circumferential surface of the hub 24, and the spline grooves 31, which are included in the second engagement portion on the inner circumferential surface of the insertion hole 25 of the gear 26. Similarly, in the second embodiment, a lubricating configuration may be provided on the sliding surface between the outer circumferential surface of the body of the bolt 47, which is included in the first engagement portion, and the inner circumferential surface of the plain bearing 46, which is included in the second engagement portion. In this case, for example, solid lubricants such as molybdenum disulfide, coatings such as fluororesin, extreme pressure lubricating oils, or extreme pressure greases may be applied to the sliding surface between the first engagement portion and the second engagement portion to facilitate lubrication.

### REFERENCE SIGNS LIST

11) Rotary kiln
20) Power transmission device
21) First power transmission member
22) Second power transmission member
24) Hub
25) Insertion hole
26) Gear
29) Spline, an example of the first engagement portion
30) Retaining ring, an example of the retaining part
31) Spline groove, an example of the second engagement portion
32) First meshing portion
33) Annular side plate, an example of the contact portion
34) Second meshing portion
41) First ring-shaped plate, an example of the retaining part
43) Second ring-shaped plate, an example of the retaining part
46) Plain bearing, an example of the second engagement portion
47) Bolt, an example of the first engagement portion
P) Axis
X) First direction
Y) Second direction

1. A power transmission device, comprising:
a first power transmission member including first meshing portions arranged next to each other in a circumferential direction about an axis extending in a first direction, the first power transmission member being rotatable about the axis; and
a second power transmission member including second meshing portions that are arranged next to each other in a second direction intersecting the first direction and are capable of meshing with the first meshing portions, the second power transmission member rotating or moving in the second direction as the first power transmission member rotates with the first meshing portions meshed with the second meshing portions, wherein
the first power transmission member includes:
a hub that rotates about the axis;
a gear including the first meshing portions on an outer circumferential side of the gear and an insertion hole on an inner circumferential side of the gear, the hub being inserted through the insertion hole to be slidable in the first direction;
a first engagement portion that moves integrally with the hub in a rotation direction of the hub; and
a second engagement portion provided on the gear to be engageable with the first engagement portion in the rotation direction of the hub.

2. The power transmission device according to claim 1, wherein
one of the gear of the first power transmission member and the second power transmission member includes a contact portion that moves the gear in a displacement direction of the second power transmission member by coming into contact with the other one of the gear of the first power transmission member and the second power transmission member in the first direction when the second power transmission member is displaced in the first direction.

3. The power transmission device according to claim 1, wherein
the hub includes a retaining part that prevents the gear, in a state in which the hub is slidably inserted through the insertion hole, from falling off from an end of the hub in the first direction by coming into contact with the gear.

4. The power transmission device according to claim 3, wherein
the retaining part is detachable from the hub.

5. The power transmission device according to claim 1, wherein
the first engagement portion extends in the first direction, and
the second engagement portion is provided on the gear to be slidable in the first direction while being engaged with the first engagement portion in the rotation direction.
